(19) United States
(12) Patent Application Publication
(10) Pub. No.: US 2008/0104173 A1
(43) Pub. Date: May 1, 2008

(54) THIRD-PARTY APPLICATION CHAT INTEGRATION

(75) Inventors: Eric M. Wilcox, Cambridge, MA (US); Werner Geyer, Boston, MA (US); Charles R. Hill, Belmont, MA (US); Sandra L. Kogan, Newton, MA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/553,753

(22) Filed: Oct. 27, 2006

(51) Int. Cl. G06F 15/16

(52) U.S. Cl. 709/205; 709/206

(57) ABSTRACT

Embodiments of the present invention address deficiencies of the art in respect to persisting threads of conversation from a messaging system and provide a method, system and computer program product for third-party application chat integration. In an embodiment of the invention, a method for third-party application chat integration can be provided. The method can include managing a thread of conversation in a messaging system, selecting at least a portion of the thread of conversation for persistence, locating information in an external, third-party application, and associating at least a portion of the thread of conversation with the located information in the external, third-party application.

### BACKGROUND OF THE INVENTION

1. Field of the Invention

The present invention relates to the field of messaging systems including persistent chats and instant messaging, and more particularly to the persistence of a thread of conversation managed in a messaging system.

2. Description of the Related Art

Real time communications systems provide a substantial enhancement over more traditional, asynchronous communications systems. Electronic mail delivery systems, the prototypical asynchronous communications systems, in its time represented a giant leap forward in respect to global interpersonal communications. Prior to electronic mail, individuals primarily communicated via telephone, facsimile and post. With electronic mail, however, individuals expect near instant delivery of text, and even imagery, audio and video, without incurring the delay typical of the postal system, or the expense associated with telephony and fax technologies.

Despite the ubiquity of electronic mail, asynchronous communications systems lack several elements common in the realm of real time communications systems. In particular, the seemingly instant delivery of a message cannot be experienced in the world of electronic mail. In an real-time society, the minor latencies associated with electronic mail often cannot be suitable for the task at hand where a real-time conversation will be required in addressing a problem or performing a collaborative task. More importantly, often the feel and nature of a “conversation” as it is known to human beings only can be approximated through real time communications where the participants to a conversation feel the spontaneity of an exchange of ideas, much as is the case in a live, face-to-face conversation.

The recent rapid development of the Internet has led to advanced modes of synchronous, real-time collaboration able to fulfill the real-time communicative requirements of the modern computing participant. Using the Internet as a backbone, individuals worldwide can converge in real-time in cyberspace to share ideas, documents and images in a manner not previously possible through conventional telephony and video conferencing. To facilitate collaboration over the Internet, a substantial collection of technologies and protocols have been assembled to effectively deliver audio, video and data over the single data communications medium of the Internet. These technologies include several human-to-human collaborative environments such as instant messaging, application sharing, shared document libraries and persistent chat rooms.

Threads of conversation produced within messaging systems often relate to information disposed within a third-party application such as a personal information manager, calendaring and scheduling (C&S) system, or customer relationship management (CRM) application. Yet, while interactions with the third-party application can be expressly associated with data in the third-party application, for threads of conversation produced by a messaging system, the threads of conversation cannot be expressly associated with data in the third-party application. Rather, at best threads of conversation can be persisted only to a file in the file system for the host computing platform. Consequently, persisted threads of conversation relating to data in a third-party application lack the requisite context provided by the data of the third-party application.

### BRIEF SUMMARY OF THE INVENTION

Embodiments of the present invention address deficiencies of the art in respect to persisting threads of conversation from a messaging system and provide a novel and non-obvious method, system and computer program product for third-party application chat integration. In an embodiment of the invention, a method for third-party application chat integration can be provided. The method can include managing a thread of conversation in a messaging system, selecting at least a portion of the thread of conversation for persistence, locating information in an external, third-party application, and associating at least a portion of the thread of conversation with the located information in the external, third-party application.

In one aspect of the embodiment, selecting at least a portion of the thread of conversation for persistence can include selecting an attachment in the thread of conversation for persistence. Alternatively, selecting at least a portion of the thread of conversation for persistence can include selecting the thread of conversation for persistence. In another aspect of the embodiment, locating information in an external, third-party application can include locating a record in a CRM application, such as an incident record. Alternatively, locating information in an external, third-party application can include locating a record in a C&S application, such as a hierarchy of tasks for an activity in an activity explorer. In yet another aspect of the embodiment, locating information in an external, third-party application can include locating the record from amongst a subset of records within a quick pick list of records in a user interface for the messaging system. Finally, locating information in an external, third-party application can include locating a portion of a hierarchy in an external document, such as a position in a word processing document having hierarchical structure, or a cell in a spreadsheet having a hierarchical structure.

In another embodiment of the invention, a messaging data processing system configured for third-party application chat integration can be provided. The system can include a messaging system configured to manage a thread of conversation, and third-party application insertion logic. The logic can include program code enabled to select at least a portion of the thread of conversation for persistence, locate a record in an external, third-party application, and associate at least a portion of the thread of conversation with the located record. The portion of the thread of conversation can include an attachment to a posting to the thread of conversation. Finally, the messaging system can include a user interface that can include multiple user interface elements. The user interface elements can include a quick pick list of records in the external, third-party application. The pick list in turn further can include an activatable link for locating a record in the external, third-party application.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1A is a screenshot of a messaging system user interface configured for third-party application chat integration;

FIG. 1B is a screenshot of the messaging system user interface of FIG. 1A, activated to persist a thread of conversation in an external record of an external third-party application;

FIG. 1C is a screenshot of the messaging system user interface of FIG. 1A, activated to persist an attachment from a thread of conversation in an external record of an external third-party application;

FIG. 2 is a schematic illustration of a messaging data processing system configured for third-party application chat integration; and,

FIG. 3 is a flow chart illustrating a process for third-party application chat integration.

### DETAILED DESCRIPTION OF THE INVENTION

Embodiments of the present invention provide a method, system and computer program product for third-party application chat integration. In accordance with an embodiment of the present invention, a user interface for a messaging system can be configured to manage and display chat postings in a thread of conversation. Concurrently, a communicative linkage can be established with a third-party application and an external record can be located in the third-party application from the user interface of the messaging system. Thereafter, the thread of conversation can be persisted in association with the external record in the third-party application. In this way, the thread of conversation can acquire context by way of the external record of the third-party application.

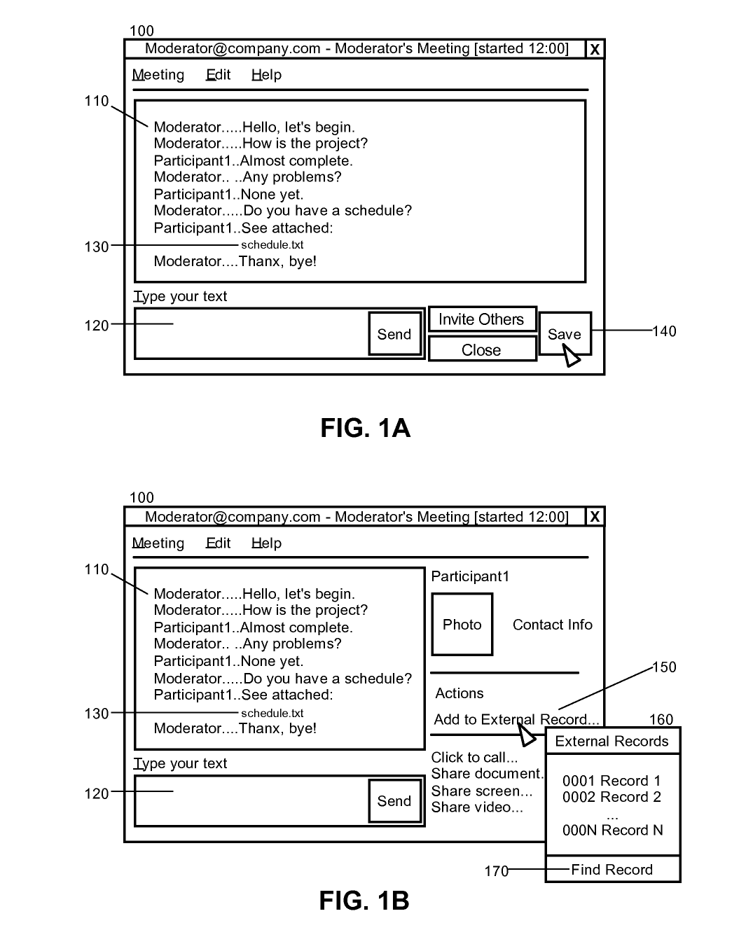

In illustration, FIG. 1A is a screenshot of a messaging system user interface configured for third-party application chat integration. The messaging system user interface 100 can provide a visual user interface for participants to an instant messaging session or persistent chat (collectively referred to herein as a “chat”). A chat can include one or more threads of conversation and the messaging system user interface 100 can include a thread display 110 for a thread of conversation. Participants can post contributions to the thread of conversation through a text entry field 120. Additionally, the thread of conversation rendered in the thread display 110 can include one or more attachments 130 as it is well-known in the art.

Notably, an activatable user interface element 140 can be provided to command the persistence of a portion or the entirety of the thread of conversation in the thread display 110. The persistence of the thread of conversation, either in its entirety, or merely a portion, can include storing the thread of conversation generally, or in association with an external record in an external, third party application. Examples of external, third-party application can include a C&S system and a CRM system to name only two. Through the activation of the activatable user interface element 140, additional user interface elements can be provided in the messaging system user interface 100 in order to further refine a selection of an external record in the external third-party application.

In further illustration, FIG. 1B is a screenshot of the messaging system user interface of FIG. 1A, activated to persist a thread of conversation in an external record of an external third-party application. As shown in FIG. 1B, the messaging system user interface 100 can be augmented to provide additional user interface elements to locate and select an external record in an external, third-party application in association with which all or a portion of a thread of conversation can be stored in the external, third-party application. The additional user interface elements can include an activatable link 150 to add the thread of conversation (or merely a portion) to an external record.

A quick pick list 160 further can be provided in response to the activation of the activatable link 150. The quick pick list 160 can provide a listing of a sampling of known external records for a third-party external application. Additionally, the quick pick list 160 can include an activatable link 170 to locate additional external records in the third-party external application. In this way, a participant interacting with the messaging system user interface 100 can associate any portion of a thread of conversation in the thread display 110 with any accessible external record for an external, third-party application in order to provide context for the thread of conversation.

The entirety of the thread of conversation, or merely a portion of the thread of conversation can be persisted in association with an external record for a third-party, external application. One portion of a thread of conversation that can be persisted is an attachment in the thread of conversation. In illustration, FIG. 1C is a screenshot of the messaging system user interface of FIG. 1A, activated to persist an attachment from a thread of conversation in an external record of an external third-party application. As shown in FIG. 1C, an attachment 130 to a thread of conversation in the thread display 110 can be selected for incorporation in an external record 190 through the quick pick list 180. For instance, where the third-party application is an activity explorer for a C&S system, the attachment can be included as a sub-task in a hierarchy of tasks for an activity.

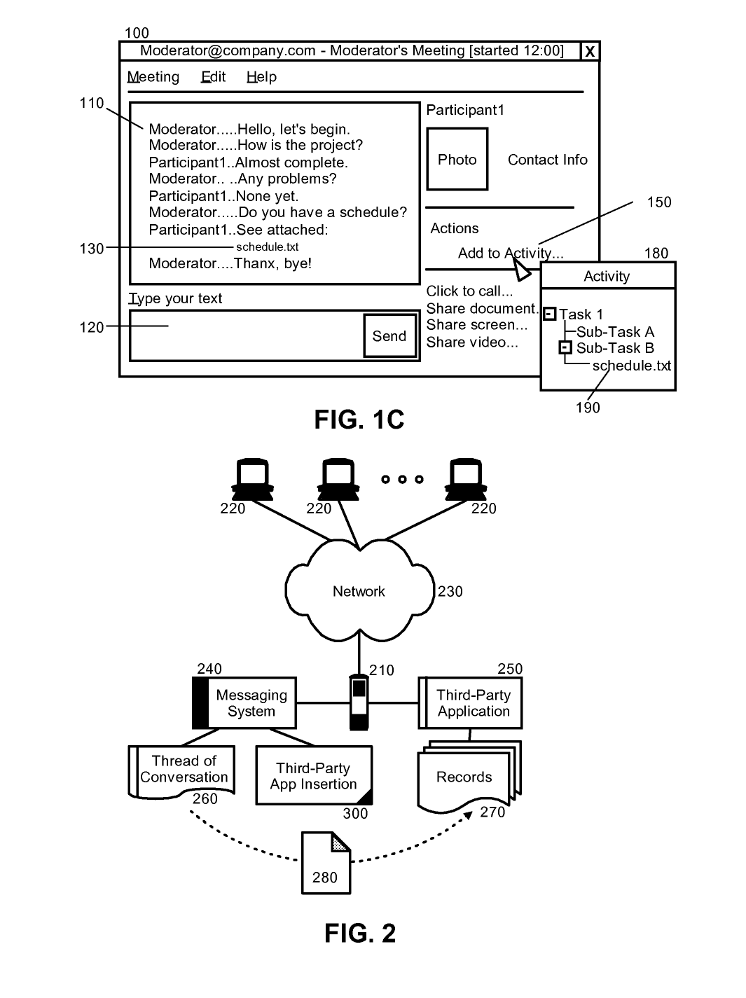

The chat integration for third-party applications can be supported by a messaging data processing system. In further illustration, FIG. 2 is a schematic illustration of a messaging data processing system configured for third-party application chat integration. The message data processing system can include a host computing platform 210 communicatively coupled to one or client computing platforms 220 over a computer communications network 230. The host computing platform 210 can include a configuration to support the operation of a messaging system 240 such as an instant messaging server or a persistent chat server.

The host computing platform 210 also can include a configuration to support the operation of a third party application 250 such as a C&S system or a CRM application, though it is to be understood that other computing platforms can support the operation of the third party application 250 whilst the host computing platform 210 can maintain a communicative coupling to the third party application 250. In any case, the third-party application 250 can include a set of records as would be expected of a C&S application or a CRM application. In the present invention, a portion of 280 or the entirety of 280 a thread of conversation 260 can be stored in association with a selected one of the records 270.

In this regard, third-party application insertion logic 300 can be coupled to the messaging system 240. The third-party application insertion logic 300 can include program code enabled to select a portion of 280 or the entirety of 280 of a thread of conversation 260 for persistence in association with an external record 270 of the third-party application 250. The external record 270 can include an activity or set of tasks in a task hierarchy in an activity explorer for a C&S system, for instance, or an incident record for a customer in a CRM system. In either circumstance, context can be added to the thread of conversation 260 through its storage in association with the record 270.

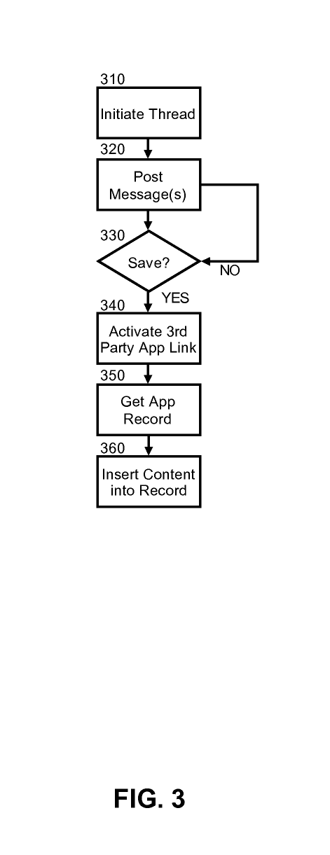

In more particular illustration of the operation of the third-part application insertion logic, FIG. 3 is a flow chart illustrating a process for third-party application chat integration. Beginning in block 310, a thread of conversation can be initiated in a messaging system. In block 320, one or more messages can be posted to the thread of conversation, including message attachments. In decision block 330, if it is requested to persist some or all of the content of the thread of conversation, in block 340 a communicative link can be established with an external, third-party application. Thereafter, in block 350 a record for the third-party application can be selected and in block 360, the content of the thread of conversation can be inserted into the record.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for third-party application chat integration, the method comprising:
managing a thread of conversation in a messaging system;
selecting at least a portion of the thread of conversation for persistence;
locating information in an external, third-party application; and,
associating at least a portion of the thread of conversation with the located information in the external, third-party application.

2. The method of claim 1, wherein selecting at least a portion of the thread of conversation for persistence, comprises selecting an attachment in the thread of conversation for persistence.

3. The method of claim 1, wherein selecting at least a portion of the thread of conversation for persistence, comprises selecting the thread of conversation for persistence.

4. The method of claim 1, wherein locating information in an external, third-party application, comprises, locating a record in a customer relationship management (CRM) application.

5. The method of claim 1, wherein locating information in an external, third-party application, comprises, locating a record in a calendaring and scheduling (C&S) application.

6. The method of claim 4, wherein locating information in an external, third-party application, comprises, locating an incident record in a CRM application.

7. The method of claim 5, wherein locating information in an external, third-party application, comprises, locating a hierarchy of tasks for an activity in an activity explorer for a C&S application.

8. The method of claim 1, wherein locating information in an external, third-party application, comprises locating the record from amongst a subset of records within a quick pick list of records in a user interface for the messaging system.

9. A messaging data processing system configured for third-party application chat integration, the system comprising:
a messaging system configured to manage a thread of conversation; and,
third-party application insertion logic comprising program code enabled to select at least a portion of the thread of conversation for persistence, locate information in an external, third-party application, and associate at least a portion of the thread of conversation with the located information.

10. The system of claim 9, wherein the portion of the thread of conversation comprises an attachment to a posting to the thread of conversation.

11. The system of claim 9, wherein the messaging system comprises a user interface comprising a plurality of user interface elements, the user interface elements comprising a quick pick list of records in the external, third-party application.

12. The system of claim 11, wherein the quick pick list further comprises an activatable link for locating a record in the external, third-party application.

13. A computer program product comprising a computer usable medium having computer usable program code for third-party application chat integration, the computer program product including:
computer usable program code for managing a thread of conversation in a messaging system;
computer usable program code for selecting at least a portion of the thread of conversation for persistence;
computer usable program code for locating information in an external, third-party application; and,
computer usable program code for associating at least a portion of the thread of conversation with the located information in the external, third-party application.

14. The computer program product of claim 13, wherein the computer usable program code for selecting at least a portion of the thread of conversation for persistence, comprises computer usable program code for selecting an attachment in the thread of conversation for persistence.

15. The computer program product of claim 13, wherein the computer usable program code for selecting at least a portion of the thread of conversation for persistence, comprises computer usable program code for selecting the thread of conversation for persistence.

16. The computer program product of claim 13, wherein the computer usable program code for locating information in an external, third-party application, comprises, computer usable program code for locating a record in a customer relationship management (CRM) application.

17. The computer program product of claim 13, wherein the computer usable program code for locating information in an external, third-party application, comprises, computer usable program code for locating a record in a calendaring and scheduling (C&S) application.

18. The computer program product of claim 16, wherein the computer usable program code for locating information in an external, third-party application, comprises, computer usable program code for locating an incident record in a CRM application.

19. The computer program product of claim 17, wherein the computer usable program code for locating information in an external, third-party application, comprises, computer usable program code for locating a hierarchy of tasks for an activity in an activity explorer for a C&S application.

20. The computer program product of claim 13, wherein the computer usable program code for locating information in an external, third-party application, comprises computer usable program code for locating the record from amongst a subset of records within a quick pick list of records in a user interface for the messaging system.
